(19) United States
(12) Patent Application Publication
(10) Pub. No.: US 2026/0328139 A1
(43) Pub. Date: Oct. 22, 2026

(54) RETENTION SYSTEMS FOR INSULATED TUBING

(71) Applicant: Mitsubishi Power Aero LLC., Glastonbury, CT (US)

(72) Inventors: Sanjay S. Hingorani, Johns Creek, GA (US); Lex Poth, Poth, TX (US)

(21) Appl. No.: 19/453,395

(22) Filed: Jan. 20, 2026

Related U.S. Application Data
(60) Provisional application No. 63/747,739, filed on Jan. 21, 2025.

(51) Int. Cl. F02C 7/24; F02C 7/06; F02C 7/12; F16L 57/04; F16L 59/02

(52) U.S. Cl. CPC F02C 7/24; F02C 7/06; F02C 7/12; F16L 57/04; F16L 59/024; F05D 2260/20

(57) ABSTRACT

An insulated tube assembly comprises a tubular body with an internal lumen, an insulation member surrounding the tubular body, and a heat shield comprising first and second shell structures encircling the insulation member. The first shell structure comprises first and second ends, and first and second slots along the first and second ends, respectively. The second shell structure comprises third and fourth ends that fit underneath the first and second ends. A retention band encircles the first and second shell structures and extends through the first and second slots while maintaining tangential retention band contact with the heat shield to eliminate stress concentrations that cause retention failure in gas turbine engine environments. A gas turbine engine comprises a compressor, combustor, and turbine, with a support structure having an inner ring, outer ring, and web. The insulated tube assembly can be connected to the support structure to convey cooling fluid.

### RELATED APPLICATIONS

This application claims the benefit of priority to U.S. Provisional Patent Application Ser. No. 63/747,739, filed Jan. 21, 2025, the content of which is incorporated herein by reference in its entirety.

### TECHNICAL FIELD

This document pertains generally, but not by way of limitation, to gas turbine power plants. More specifically, but not by way of limitation, the present application relates to systems and methods for conveying fluids and extending components between locations in a gas turbine power plant using insulated tubing.

### BACKGROUND

In a gas turbine power plant, a gas turbine engine can be operated to directly generate electricity with a generator using shaft power. Compressed air and fuel can be combusted to produce exhaust gas to rotate a turbine of the gas turbine engine. The turbine can be used to drive a compressor to produce the compressed air and an electrical generator to produce electricity.

A gas turbine engine includes a number of structural components as well as various hot working fluid flow paths and coolant flow paths. The flow paths allow fluids, such as oil, lubricant, air, etc., to provide temperature control of structural components exposed to the hot working fluid to maintain integrity and efficiency of the engine. For example, it is desirable to provide cooling to moving components such as bearings that support rotating shafts within the gas turbine engine. Thus, various ducts and tubular elements can be provided to extend between different locations within the gas turbine engine to convey fluids at various temperatures. Such ducts and tubes can also be used as passages for hardware, such as wiring and the like.

### OVERVIEW

The present inventors have recognized problems in maintaining service tubes, cooling fluid ducts and other passages within gas turbine engine structures. Fluid ducts transport relatively hot and cold fluids within the gas turbine engine structure, making it desirable to attach insulating material to the exterior of the fluid duct to maintain a temperature differential between the exterior and interior. However, attaching and maintaining insulating structures to the exterior of fluid ducts presents challenges due to operating conditions. Fasteners, typically wires wrapped or wound around an outer shell of the insulating structure, are attached when the gas turbine engine is not running and the system is at ambient temperature. During operation, the insulating structure on the exterior of the fluid duct, including the fasteners, heats up more than the fluid duct itself and the insulating material contained within the outer shell. This differential thermal expansion causes the insulating structure and fasteners to expand more than the fluid duct and differently from each other. The expansion can cause loosening of the insulating structure and fasteners, which, combined with air currents generated during operation, can result in vibration and rattling of the insulating structure. The insulating structure can rub against the fasteners, potentially causing stress and breakage. This problem is exacerbated by the construction of the insulating structure, which typically comprises two shell portions that mate together to hold insulating material around the fluid duct. The two shell portions include overlapping edges to ensure the insulating material is fully surrounded, but the corners of the exterior edges can produce stress concentration points in the fastener where the fastener contacts the edges. Thus, the edges of the shell portions can disrupt the continuity of the fasteners with the shell surface.

The subject matter of the present disclosure can provide solutions to these problems and other problems by providing insulating structures that reduce or eliminate stress concentrations in fasteners caused by corners of overlapping edges in shell structures. The shell structures and fasteners of the present disclosure are configured to maintain tangency of fasteners, e.g., wires and/or retention bands, around the entire circumference of the fluid duct, or substantially all of the circumference. An edge of the outer shell structure can disrupt the tangency of the fastener, placing the edge directly against the fastener where rubbing can cause failure. The present disclosure addresses this by incorporating slots or windows in or near edges of outer shell structures that allow fasteners to extend tangent to the outer diameter of the shell structures along their entire length of engagement. By maintaining this tangential contact, the fasteners avoid direct contact with sharp edges of the shell structures. The slots can be configured as open-ended slots extending through the edge of the shell or as closed slots with a bridging strap that maintains structural integrity while still providing a recessed pathway for the retention band. This design eliminates, or substantially reduces, the stress concentrations that occur when fasteners bend around shell edges, thereby preventing or mitigating the rubbing and wear that can lead to fastener failure and allowing the retention system to accommodate thermal expansion without failing or with a reduced tendency to fail.

This overview is intended to provide an overview of the subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1A is a schematic view of an example gas turbine engine architecture in which the retention fasteners for insulated tubing of the present disclosure can be used.

FIG. 1B is a perspective view of a portion of a support structure that can be used with insulated tubing of the present disclosure that can allow passage of fluids and objects between different locations in a gas turbine engine.

FIG. 2A is a perspective view of an insulated tube having shell structures attached using fasteners, such as a plurality of wires, extending through depressions in the shell structures.

FIG. 2B is a close-up view of the plurality of wires wrapped around the shell structures at a depression in the shell.

FIG. 2C is a cross-sectional view through the insulated tube of FIG. 2B in front of the depression showing a wire extending within the depression.

FIG. 2D is a cross-sectional view through the insulated tube of FIG. 2B through the depression showing a wire extending across edges of the shell structures.

FIG. 2E is a close-up view of the wire extending non-tangentially across an edge of the shell structures of FIG. 2D.

FIG. 3A is a perspective view of an insulated tube having shell structures attached with a fastener assembly including a plurality of wires extending through open slots in the shell structures according to the present disclosure.

FIG. 3B is a close-up view of the plurality of wires of FIG. 3A wrapped around the shell structures at an open slot.

FIG. 3C is a cross-sectional view through the insulated tube of FIG. 3B in front of the open slot showing a wire extending within the open slot.

FIG. 3D is a cross-sectional view through the insulated tube of FIG. 3B through the open slot showing a wire extending across edges of the shell structures.

FIG. 3E is a close-up view of the wire extending tangentially across an edge of the shell structures of FIG. 3D.

FIG. 4A is a perspective view of an insulated tube having shell structures attached with a fastener assembly including a plurality of wires extending through closed slots in the shell structures according to the present disclosure.

FIG. 4B is a close-up view of the plurality of wires of FIG. 4A wrapped around the shell structures at a closed slot.

FIG. 4C is a cross-sectional view through the insulated tube of FIG. 4B in front of the closed slot showing a wire extending within the closed slot.

FIG. 4D is a cross-sectional view through the insulated tube of FIG. 4B through the closed slot showing a wire extending across edges of the shell structures.

FIG. 4E is a close-up view of the wire extending tangentially across an edge of the shell structures of FIG. 4D.

FIG. 5A is a perspective view of an insulated tube having shell structures attached with a fastener assembly including a strap, a locking mechanism, and open slots according to the present disclosure.

FIG. 5B is a close-up view of the strap of FIG. 5A wrapped around the shell structures at an open slot.

FIG. 6A is a perspective view of an insulated tube having shell structures attached with a fastener assembly including a strap, a locking mechanism, and closed slots according to the present disclosure.

FIG. 6B is a close-up view of the strap of FIG. 6A wrapped around the shell structures at a closed slot.

FIG. 7 is a cross-sectional view through an insulated tube having a fastener assembly comprising a strap and a lock mechanism with a curved housing to mate with the curvature of an insulated tube assembly.

FIG. 8A is a top view of a fastener assembly suitable for use with the insulated tube assemblies of FIG. 5A through FIG. 7, showing a locking head and an elongate strap.

FIG. 8B is a side cross-sectional view through the fastener assembly of FIG. 8A, showing a ball locking mechanism.

In the drawings, which are not necessarily drawn to scale, like numerals may describe similar components in different views. Like numerals having different letter suffixes may represent different instances of similar components. The drawings illustrate, generally, by way of example, but not by way of limitation, various embodiments discussed in the present document.

### DETAILED DESCRIPTION

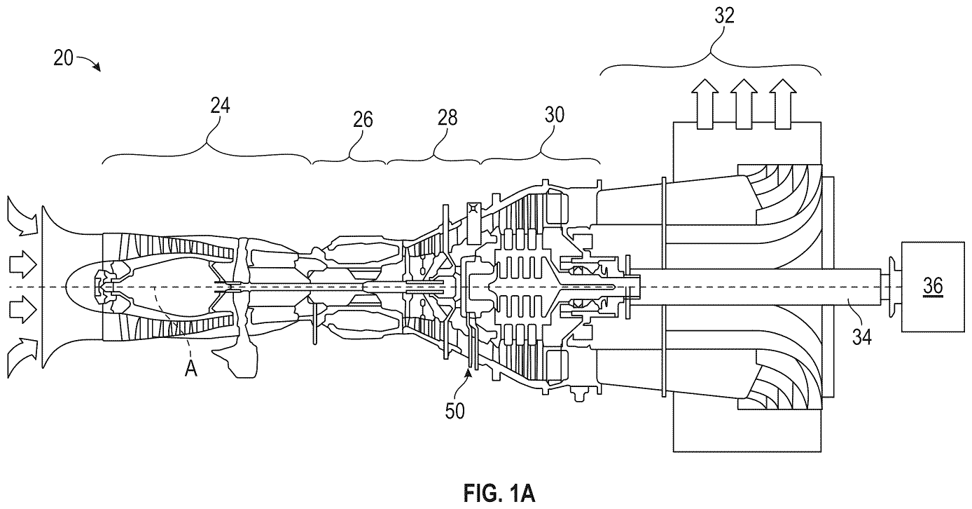

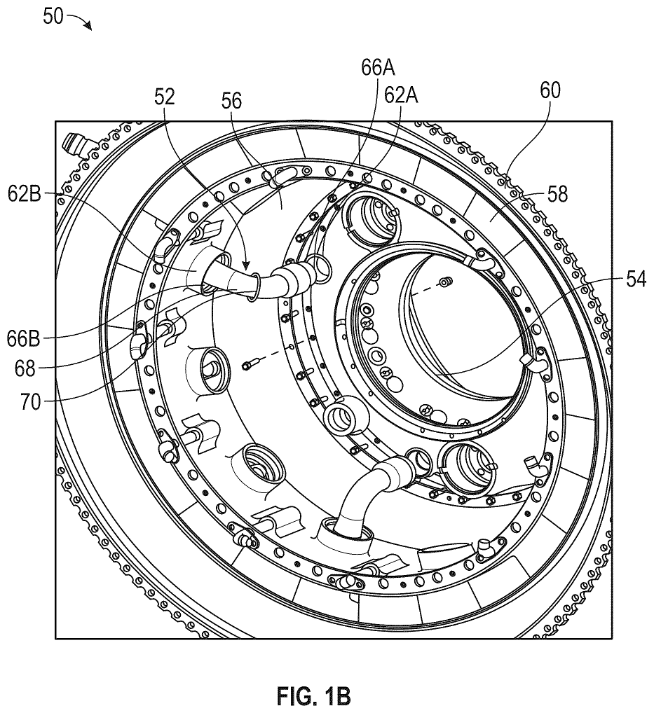

FIG. 1A schematically illustrates gas turbine engine 20. Gas turbine engine 20 can comprise compressor section 24, combustor section 26, turbine section 28, power turbine section 30, and exhaust section 32. During operation, ambient air can enter compressor section 24, where it is compressed to elevated pressure. The compressed air flows downstream into combustor section 26, where it is mixed with fuel and ignited, producing high-temperature, high-pressure combustion gases. These combustion gases expand through turbine section 28, driving rotation of turbine blades that extract energy from the gas flow. Turbine section 28 is mechanically coupled to compressor section 24, such as via a shaft, to drive the compression process. The partially expanded combustion gases then flow into power turbine section 30, which drives output shaft 34 to power generator 36 or other systems. The spent combustion gases exit through exhaust section 32. Compressor section 24, combustor section 26, and turbine section 28 together form a gas generator section that produces the high-energy gas stream for power turbine section 30. In one disclosed non-limiting embodiment, power turbine section 30 includes a free turbine with no physical connection between the gas generator section and power turbine section 30, allowing the power turbine to rotate independently while capturing energy from the mass flow of combustion gases. In other examples, power turbine section 30 can be directly driven by a shaft connected to turbine section 28. In additional examples, power turbine section 30 can be omitted, and the gas generator section can drive an electrical generator either at compressor section 24 or turbine section 28. Gas turbine engine 20 can be situated within a ground-mounted enclosure typical of an industrial gas turbine (IGT). The engine structure includes various static or non-rotating structural components used to mount compressor section 24 and turbine section 28 for rotation within the ground-mounted enclosure. These structural components accommodate various ducts and tubes that allow passage of fluids and components between the various sections of gas turbine engine 20, including cooling fluids, lubricants, and control system components. As discussed herein, these ducts and tubes can include heat shields and fasteners that, according to the present disclosure, are better suited to surviving harsh thermal environments that can induce thermal expansion that can potentially produce stress concentrations in fasteners used to attach heat shields to the ducts and tubes.

Although depicted as a specific engine architecture in the disclosed non-limiting embodiment, it should be understood that the concepts described herein are not limited to only such architecture, as the teachings may be applied to other gas turbine architectures or in other applications and environments. For example, the retention system for insulated tubing of the present disclosure can be used in gas turbine engines used in aviation, rocket engines, hypersonic vehicles, and in other industrial settings, such as boiler systems, furnace systems, steam plants, power generation plants, and the like.

FIG. 1B is a perspective view of support structure 50 that can be used with insulated tube 52 to allow passage of fluids and objects between different locations in gas turbine engine 20 of FIG. 1A. Support structure 50 can comprise inner ring 54, web 56, and outer ring 58.

Support structure 50 can function as a structural frame or support element within gas turbine engine 20, providing mechanical support and defining pathways for fluid conveyance and component routing. Outer ring 58 can be used to connect to other structural components, such as casings, vane rings, and other frame elements within the gas turbine architecture. Outer ring 58 can include connection flange 60, which provides a bolted or otherwise mechanically fastened interface to adjacent structural components. Inner ring 54 can be used to connect to other structural components or can surround rotating components of gas turbine engine 20, such as a shaft that connects compressor section 24 and turbine section 28 at a radially inner position within combustor section 26. In examples, inner ring 54 can be used to support a bearing assembly that allows rotation of the shaft while maintaining precise radial positioning and load distribution. Web 56 extends radially between inner ring 54 and outer ring 58, providing structural connectivity and load transfer between the inner and outer rings while defining open spaces through which fluid tubes, control lines, and other components can pass. Web 56 can include first socket 62A and second socket 62B for connecting to insulated tube 52. First socket 62A and second socket 62B can provide mounting interfaces that mechanically secure the ends of insulated tube 52 to support structure 50, allowing insulated tube 52 to traverse the space within the gas turbine engine structure while being supported at defined connection points. Though described with reference to a frame that supports a bearing assembly, the retention systems for insulated tubing of the present disclosure can be used in other locations within a gas turbine engine, such as with other frames and the like.

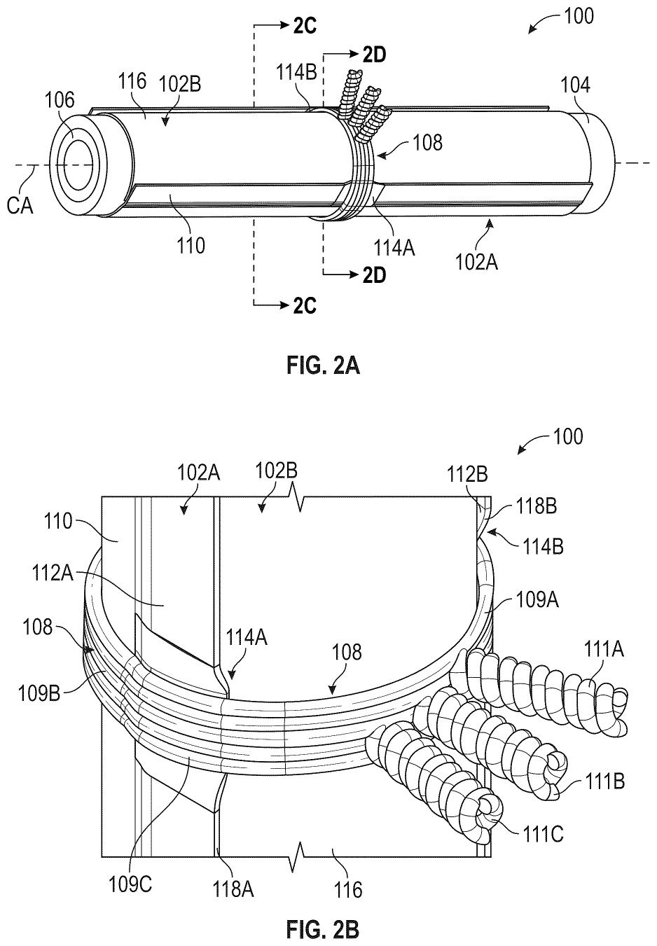

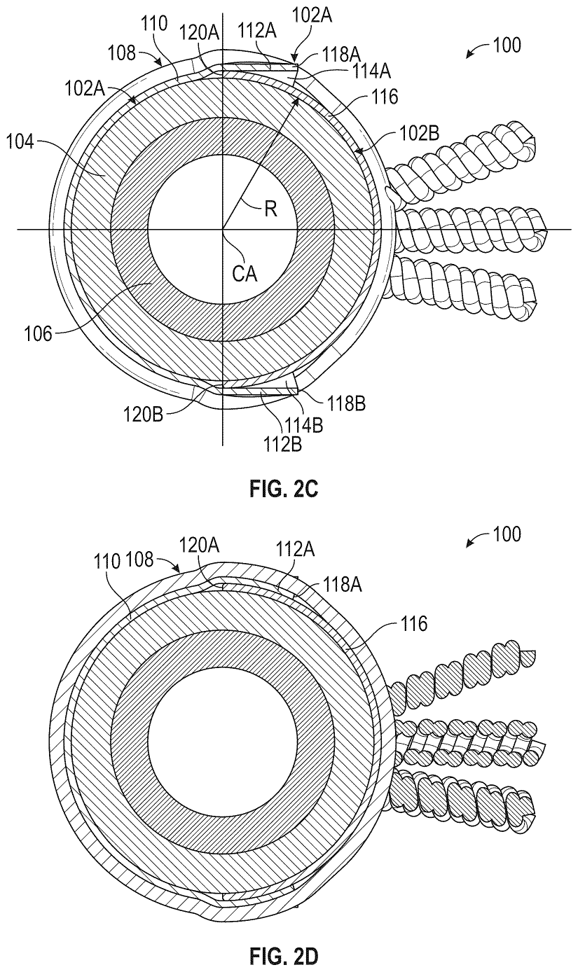

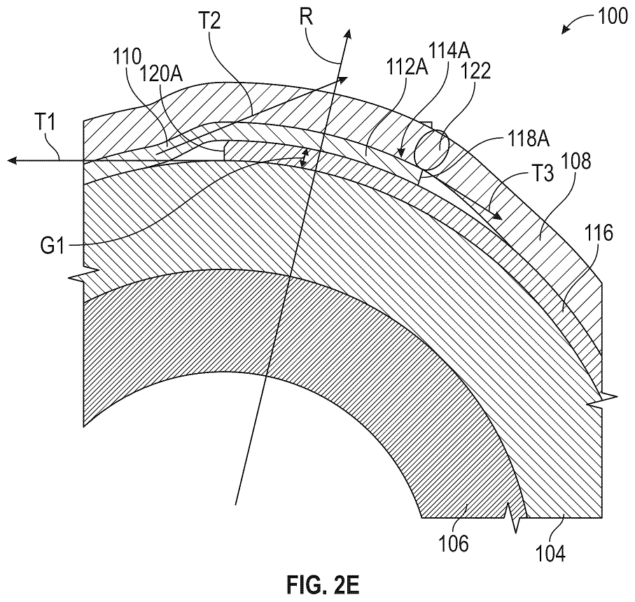

FIG. 1B shows insulated tube 52 comprising a curved body extending between first socket 62A and second socket 62B. The curved configuration allows insulated tube 52 to route around obstructions within the gas turbine engine structure and to accommodate the spatial constraints imposed by the cylindrical geometry of the engine. Insulated tube 52 can have any shape depending on the routing pathways between connection points. In the illustrated example, insulated tube 52 comprises two legs of approximately equal length angled relative to each other at approximately ninety-degrees. However, insulated tube 52 can have two legs arranged at other angles or with legs of different lengths, can include more than two legs, can be straight, or have other shapes. Insulated tube 52 can include first flange 66A and second flange 66B located on opposite sides of an elongate body, e.g., tube 106 of FIG. 2A. First flange 66A and second flange 66B can be configured to mate with first socket 62A and second socket 62B, respectively, providing a sealed or mechanically secure connection that prevents fluid leakage and maintains the position of insulated tube 52 during operation. The exterior of the elongate body can comprise shell assembly 68 having a first shell and a second shell (e.g., first shell structure 102A and second shell structure 102B of FIG. 2B), which can be held in engagement with the elongate body by one or more fasteners. The shell assembly 68 functions as a heat shield that surrounds insulation material (e.g., insulation 104 of FIG. 2C) and protects the insulation material from direct exposure to the high-temperature environment within the gas turbine engine.

In examples, fastener 70 can comprise one or more wires, e.g., plurality of wires 108 of FIG. 2A, wrapped or wound around the first shell and the second shell, each having ends thereof twisted together to cinch the wire around the shell assembly and maintain compressive engagement between the shell structures and the underlying insulation. The first shell and the second shell can be used to hold insulation material, e.g., insulation 104 of FIG. 2C, around the elongate body, creating a thermal barrier between the fluid within the tube and the external environment. In examples, the elongate body can comprise a metal tube that has high heat resistance and structural stability, such as ceramic matrix composite materials, cobalt-based alloys, nickel-based alloys, titanium-based alloys, chromium-based alloys, stainless steel, and the like, allowing the tube to maintain structural integrity and resist corrosion in the high-temperature gas turbine environment. The insulation material can comprise an insulating material or member, such as fiberglass, cellulose, calcium silicate, mineral wool, ceramic fiber, aerogel, and the like, which provides low thermal conductivity to minimize or reduce heat transfer between the exterior environment and the fluid within the tube. The first shell and the second shell can comprise a metal with high conductivity and strength, such as aluminum and ceramic, providing a durable outer surface that can withstand mechanical loads and protect the insulation material from damage due to vibration, air currents, and contact with other components. The combination of the metal tube, insulation material, and metal shell structures creates a multi-layer assembly that maintains temperature control of the conveyed fluid while withstanding the mechanical and thermal stresses present in the gas turbine operating environment.

In examples, insulated tube 52 can be used to deliver cold cooling fluid to a bearing assembly from another location within gas turbine engine 20. However, web 56 can be exposed to hot air within gas turbine engine 20. In an example, insulated tube 52 can be used in an environment where the external temperature surrounding insulated tube 52 can be approximately 1300° F. (~704° C.) and the temperature of fluid within insulated tube 52 can be approximately 300° F. (~149° C.). Thus, it can be desirable to insulate the exterior of insulated tube 52 from air surrounding insulated tube 52 to prevent undesirable heating of cooling fluid therein. However, the present disclosure can be used in association with other tubes or ducts configured to convey hot fluid or that facilitate passage of non-fluid objects, such as wires, mechanical linkages, and the like.

With the present disclosure, shell assembly 68 can be shaped, such as to include open and/or closed slots and other features, to allow fastener 70 to encircle shell assembly 68 along a substantially circular path to eliminate stress concentrations within plurality of wires 108. The slots, or portals or windows, can allow fastener 70 to maintain tangency to shell assembly 68 by passing through the shell structures to reduce or eliminate fastener 70 having to bend around edges of shell structures.

FIG. 2A is a perspective view of insulated tube assembly 100 having first shell structure 102A and second shell structure 102B holding insulation 104 against tube 106. Tube 106 and insulation 104 can extend along central axis CA. In the illustrated embodiment, insulated tube assembly 100 extends straight along central axis CA. However, insulated tube assembly 100 can be curved or angled as discussed herein. In examples, insulated tube assembly 100 can comprise insulated tube 52 of FIG. 1B, or a portion thereof. Insulation 104 and tube 106 are illustrated as being longer than first shell structure 102A and second shell structure 102B for illustrated purposes. In examples, first shell structure 102A and second shell structure 102B can cover insulation 104 and tube 106 along the entire axial length thereof.

Insulated tube assembly 100 of FIG. 2A through FIG. 2E represents a retention approach that can experience the problems described above related to stress concentrations from rubbing against edges of shell structures. Plurality of wires 108 are wrapped around the exterior of first shell structure 102A and second shell structure 102B in an attempt to maintain the shell structures in compressive engagement with insulation 104. In the illustrated example, plurality of wires 108 can comprise first wire 109A, second wire 109B and third wire 109C. First wire 109A can be wrapped around insulated tube assembly 100 one or more times, and ends of first wire 109A can be twisted together to form first twisted pair 111A. Second wire 109B can be wrapped around insulated tube assembly 100 one or more times, and ends of second wire 109B can be twisted together to form second twisted pair 111B. Third wire 109C can be wrapped around insulated tube assembly 100 one or more times, and ends of third wire 109C can be twisted together to form third twisted pair 111C. Tube 106 forms the innermost structural element and defines an internal lumen through which fluid can flow or other components, such as wiring, can be disposed. Tube 106 can be fabricated of structural materials, such as ceramic matrix composite materials, cobalt-based alloys, nickel-based alloys, titanium-based alloys, chromium-based alloys, stainless steel, and the like. Insulation 104 surrounds tube 106 and provides thermal resistance to reduce heat transfer between the fluid within tube 106 and the external environment. Insulation 104 can comprise fiberglass, cellulose, calcium silicate, mineral wool, ceramic fiber, aerogel, and the like. First shell structure 102A and second shell structure 102B together form a protective outer shell that encases insulation 104 and protects it from mechanical damage, air currents, and direct exposure to the high-temperature environment within the gas turbine engine. First shell structure 102A and second shell structure 102B can be fabricated of metals or materials that provide structural rigidity and good heat transfer properties, such as aluminum and ceramic.

FIG. 2B is a close-up view of first shell structure 102A and second shell structure 102B being held together with plurality of wires 108 at the location of depression 114A. First shell structure 102A can comprise arcuate body 110 having first flared end portion 112A, second flared end portion 112B, depression 114A, and depression 114B. Depression 114A is shown in first flared end portion 112A and second flared end portion 112B can include a second, similar depression, e.g., depression 114B, along the same circumferential path around insulated tube assembly 100. Depression 114A can be formed in arcuate body 110 to provide a recessed area where plurality of wires 108 can be positioned. Second shell structure 102B can comprise arcuate body 116, which has a simpler curved profile without flared end portions. Arcuate body 110 can have first edge 118A and second edge 118B that define the longitudinal boundaries of first shell structure 102A. In other words, first edge 118A and second edge 118B can extend longitudinally, e.g., parallel or nearly parallel to central axis CA, and can comprise the circumferential extent of arcuate body 110. Arcuate body 116 can have first edge 120A and second edge 120B that define the longitudinal boundaries of second shell structure 102B. In other words, first edge 120A and second edge 120B can extend longitudinally, e.g., parallel or nearly parallel to central axis CA, and can comprise the circumferential extent of arcuate body 116. The configuration shown in FIG. 2A and FIG. 2B illustrates an approach where depression 114A in first shell structure 102A and depression 114B in second shell structure 102B are intended to accommodate plurality of wires 108, but as will be shown in subsequent figures, this configuration does not adequately address the stress concentration problem, as discontinuities in the arcuate extent of plurality of wires 108 are introduced.

FIG. 2C is a cross-sectional view through insulated tube assembly 100 of FIG. 2B taken at a location in front of depression 114A, showing plurality of wires 108 extending within depression 114A. This cross-sectional view reveals the layered construction of insulated tube assembly 100, with tube 106 at the center, insulation 104 surrounding tube 106, and first shell structure 102A and second shell structure 102B encircling insulation 104. In this cross-sectional plane, plurality of wires 108 are positioned within depression 114A, which provides a recessed pathway that allows the wires to sit closer to insulation 104 thereunder, rather than projecting outward from the surface of first shell structure 102A, such as by having to bend around first flared end portion 112A. First edge 120A of second shell structure 102B is tucked underneath first flared end portion 112A of first shell structure 102A, creating an overlapping joint that ensures complete circumferential coverage of insulation 104. Similarly, second edge 120B of second shell structure 102B is tucked underneath second flared end portion 112B of first shell structure 102A at the opposite side of the assembly. This overlapping configuration is provided to accommodate the fact that at least one of the shell structures can extend more than one-hundred-eighty degrees around the circumference of insulation 104, thereby ensuring no gaps exist through which insulation 104 could be exposed to the external environment.

FIG. 2D is a cross-sectional view through insulated tube assembly 100 of FIG. 2B taken through depression 114A, showing plurality of wires 108 extending across first edge 118A and over first edge 120A of first shell structure 102A and second shell structure 102B, respectively, with first edge 120A being tucked under first flared end portion 112A. This cross-sectional view, taken at a different axial location than FIG. 2C, reveals the problem with the conventional design: plurality of wires 108 transition from extending within depression 114A to extending across the edges of the shell structures where the two shell structures overlap by undergoing a rapid change in radial position.

In order to allow first shell structure 102A and second shell structure 102B to completely surround insulation 104, one or both of first shell structure 102A and second shell structure 102B can extend over more than one-hundred-eighty degrees around the circumference of insulation 104. This configuration allows for production of a complete enclosure without gaps while using two separate shell pieces that allow for assembly around tube 106 and insulation 104. In the illustrated example, arcuate body 116 of second shell structure 102B can extend across approximately one-hundred-eighty degrees of insulation 104 between first edge 220A and second edge 220B, forming a semicircular or near-semicircular profile. Second shell structure 102B can comprise a C-shaped body that comprises a half cylinder, e.g., a body that extends around one-hundred-eighty degrees relative to the circumference of insulation 104. First shell structure 102A can extend across approximately two-hundred-twenty degrees of insulation 104 between first edge 120A and second edge 120B, thereby extending beyond a semicircle by approximately forty degrees to create the desired overlap with second shell structure 102B. First shell structure 102A can comprise a U-shaped body that comprises a half cylinder, e.g., a body that extends around almost one-hundred-eighty degrees relative to the circumference of insulation 104, plus two straight portions extending therefrom comprising first flared end portion 112A and second flared end portion 112B. The overlap provided by first shell structure 102A and second shell structure 102B can ensure that no portion of insulation 104 is exposed to the external environment and that the shell structures remain properly positioned during thermal cycling and vibration. Thus, in order to accommodate both of first shell structure 102A and second shell structure 102B partially encircling tube 106, first shell structure 102A can include first flared end portion 112A and second flared end portion 112B. These flared end portions transition outward from the primary curved profile of arcuate body 110 to create a larger radius that can accommodate the thickness of second shell structure 102B underneath. First edge 120A of second shell structure 102B can fit underneath first flared end portion 112A of first shell structure 102A and second edge 120B of second shell structure 102B can fit underneath second flared end portion 112B of first shell structure 102A, creating a nested or overlapping joint configuration at both circumferential locations where the two shell structures meet, along the longitudinal lengths. The flared end portions additionally facilitate easier assembly by allowing a user to easily position first edge 120A and second edge 120B underneath first flared end portion 112A and second flared end portion 112B.

FIG. 2E is a close-up view of one of plurality of wires 108 extending across first edge 118A of first shell structure 102A and first edge 120A of second shell structure 102B in a non-tangential fashion, illustrating the stress concentration issue that the present disclosure addresses. As can be seen in FIG. 2E, arcuate body 116 of second shell structure 102B can extend around the circumference of insulation 104 such that first edge 120A extends along trajectory T1 that is tangent to insulation 104. This tangential trajectory represents the natural circular path that follows the outer surface of insulation 104 at a consistent radius. Similarly, arcuate body 110 of first shell structure 102A extends around insulation 104 in a circular manner until first shell structure 102A is in close proximity to first edge 120A of second shell structure 102B. At this point, the geometry of first shell structure 102A is altered to accommodate the overlapping joint connection, thereby introducing the potential for stress concentrations. As such, first shell structure 102A is redirected along trajectory T2 radially outward from insulation 104 in order to increase its radius to form gap G1 in which arcuate body 116 can be positioned. This outward redirection creates first flared end portion 112A and allows first shell structure 102A to extend over the top of second shell structure 102B. Thereafter, arcuate body 110 of first shell structure 102A is redirected along trajectory T3 within depression 114A to extend tangent to the exterior of arcuate body 116 rather than tangent to insulation 104. As such, there is a different radial position between trajectory T1 of second shell structure 102B and trajectory T3 of first shell structure 102A relative to radial direction R. First edge 118A and first edge 120A therefore do not have the same tangency relative to the center of tube 106. Thus, when plurality of wires 108 extends around first shell structure 102A and second shell structure 102B, first edge 118A produces stress concentration 122 in plurality of wires 108. The wire bends at a sharp angle to transition from the curved surface within depression 114A to extend over first edge 118A, creating a point of contact where the wire bears against the edge rather than maintaining smooth tangential contact with a curved surface. This edge contact creates localized stress in the wire, and when combined with differential thermal expansion during operation and vibration from air currents within the gas turbine engine, causes rubbing and wear that can lead to wire failure. The design shown in FIG. 2A through FIG. 2E thus illustrates a potential weakness in plurality of wires 108 that the slot-based retention designs disclosed in subsequent figures address.

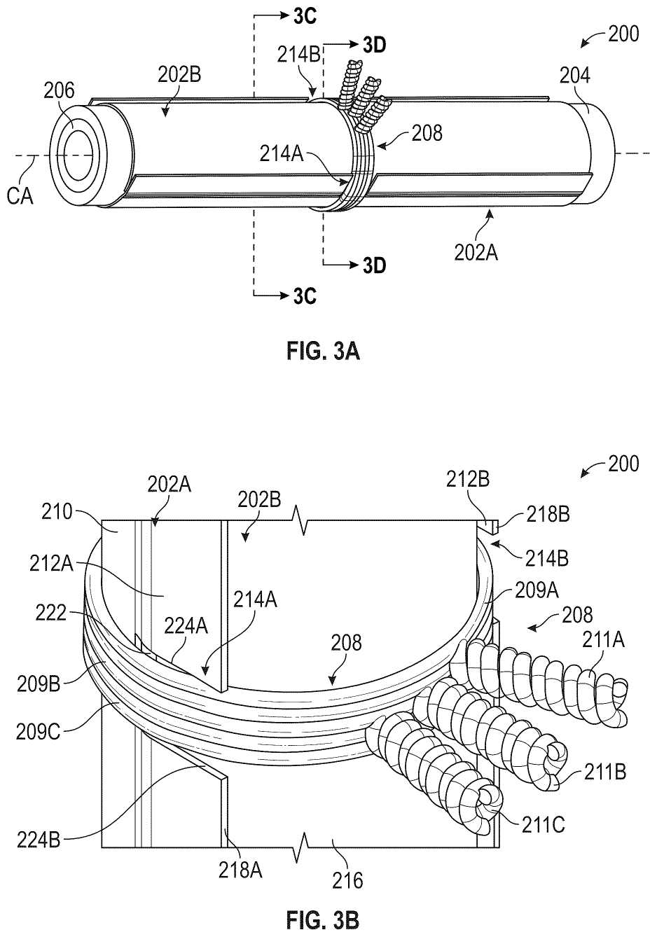

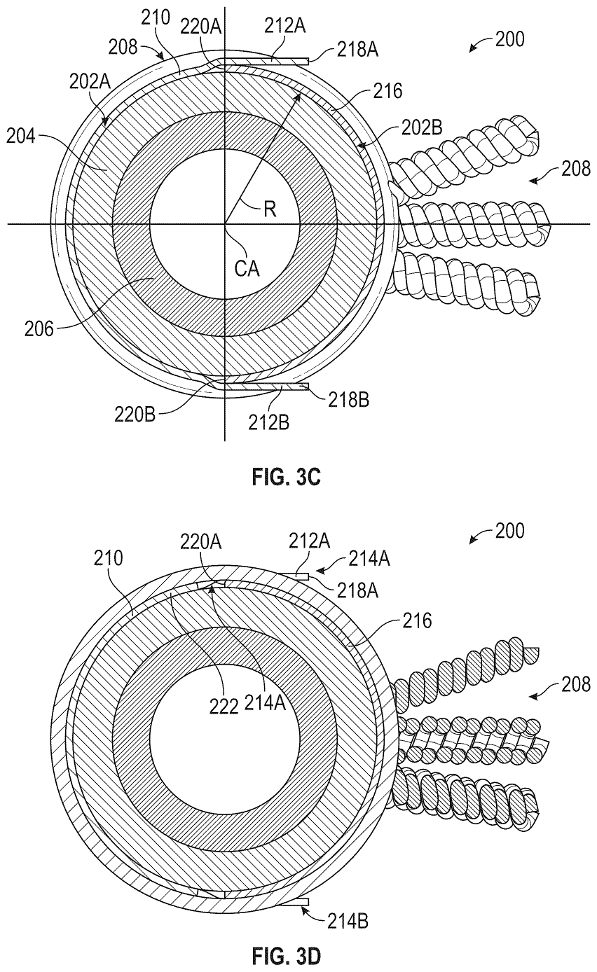

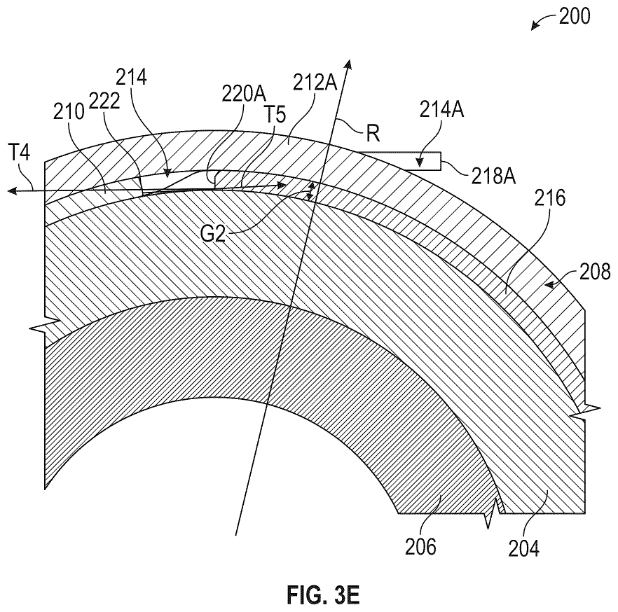

FIG. 3A is a perspective view of insulated tube assembly 200 having first shell structure 202A and second shell structure 202B holding insulation 204 against tube 206. Tube 206 and insulation 204 can extend along central axis CA. In the illustrated embodiment, insulated tube assembly 200 extends straight along central axis CA. However, insulated tube assembly 200 can be curved or angled as discussed herein. In examples, insulated tube assembly 200 can comprise insulated tube 52 of FIG. 1B, or a portion thereof. Insulation 204 and tube 206 are illustrated as being longer than first shell structure 202A and second shell structure 202B for illustrated purposes. In examples, first shell structure 202A and second shell structure 202B can cover insulation 204 and tube 206 along the entire axial length thereof.

Insulated tube assembly 200 represents an improved retention approach that addresses the stress concentration issues identified in the design of FIG. 2A through FIG. 2E. Insulated tube assembly 200 incorporates slot 214A and slot 214B to reduce or eliminate the stress concentration caused by first edge 120A and second edge 120B in the configuration of FIG. 2A through FIG. 2E.

Plurality of wires 208 are wrapped or wound around the exterior of first shell structure 202A and second shell structure 202B in an attempt to maintain the shell structures in compressive engagement with insulation 204. In the illustrated example, plurality of wires 208 can comprise first wire 209A, second wire 209B, and third wire 209C. First wire 209A can be wrapped around insulated tube assembly 200 one or more, and ends of first wire 209A can be twisted together to form first twisted pair 211A. Second wire 209B can be wrapped around insulated tube assembly 200 one or more times, and ends of second wire 209B can be twisted together to form second twisted pair 211B. Third wire 209C can be wrapped around insulated tube assembly 200 one or more times, and ends of third wire 209C can be twisted together to form third twisted pair 211C. Tube 206 forms the innermost structural element and defines an internal lumen through which fluid can flow or other components, such as wiring, can be disposed. Tube 206 can be fabricated of structural materials, such as ceramic matrix composite materials, cobalt-based alloys, nickel-based alloys, titanium-based alloys, chromium-based alloys, stainless steel, and the like. Insulation 204 surrounds tube 206 and provides thermal resistance to reduce heat transfer between the fluid within tube 206 and the external environment. Insulation 204 can comprise fiberglass, cellulose, calcium silicate, mineral wool, ceramic fiber, aerogel, and the like. First shell structure 202A and second shell structure 202B together form a protective outer shell that encases insulation 104 and protects it from mechanical damage, air currents, and direct exposure to the high-temperature environment within the gas turbine engine. First shell structure 202A and second shell structure 202B can be fabricated of metals or materials that provide structural rigidity and good heat transfer properties, such as aluminum and ceramic. In examples, each of first shell structure 202A and second shell structure 202B can have a thickness in the range of approximately 0.125 inch (~3.2 millimeters) to approximately 0.5 inch (~12.7 millimeters).

FIG. 3B is a close-up view of first shell structure 202A and second shell structure 202B being held together with plurality of wires 208 at the location of slot 214A. Unlike depression 114A in the design of FIG. 2A through FIG. 2E, slot 214A extends completely through first shell structure 202A, from a radial outer, exterior side, to a radial inner, interior side, producing an opening that allows plurality of wires 208 to pass through the shell structure rather than merely sitting in a recessed area. First shell structure 202A can comprise arcuate body 210 having first flared end portion 212A, second flared end portion 212B, slot 214A, and slot 214B. Slot 214A is shown in first flared end portion 212A, and second flared end portion 212B can include a second, similar slot, e.g., slot 214B, along the same circumferential path around insulated tube assembly 200. Second shell structure 202B can comprise arcuate body 216. Arcuate body 210 can have first edge 218A and second edge 218B that define the longitudinal boundaries of first shell structure 202A. In other words, first edge 218A and second edge 218B can extend longitudinally, e.g., parallel or nearly parallel to central axis CA, and can comprise the circumferential extent of arcuate body 210. Arcuate body 216 can have first edge 220A and second edge 220B that define the longitudinal boundaries of second shell structure 202B. In other words, first edge 220A and second edge 220B can extend longitudinally, e.g., parallel or nearly parallel to central axis CA, and can comprise the circumferential extent of arcuate body 216. The configuration shown in FIG. 3A and FIG. 3B demonstrates how slot 214A and slot 214B provide a pathway for plurality of wires 208 that maintains tangential contact with the shell structures throughout the entire circumference, thereby eliminating the sharp edge contact that causes stress concentrations and wire failure in other configurations. Thus, discontinuities in the arcuate extent of plurality of wires 208 are eliminated.

FIG. 3C is a cross-sectional view through insulated tube assembly 200 of FIG. 3B taken at an axial location in front of slot 214A and slot 214B, showing plurality of wires 208 extending within slot 214A and slot 214B. This cross-sectional view reveals the layered construction of insulated tube assembly 200, with tube 206 at the center, insulation 204 surrounding tube 206, and first shell structure 202A and second shell structure 202B encircling insulation 204. In this cross-sectional plane, plurality of wires 208 are positioned within slot 214A and slot 214B, which provides a recessed pathway similar to depression 114A and depression 114B in the design of FIG. 2A through FIG. 2E. However, the advantage of slot 214A and slot 214B allows plurality of wires 208 to extend straight across first flared end portion 212A and second flared end portion 212B by passing through first flared end portion 212A and second flared end portion 212B and not having to bend around first flared end portion 212A and second flared end portion 212B. First edge 220A of second shell structure 202B is tucked underneath first flared end portion 212A of first shell structure 202A, creating an overlapping joint that ensures complete circumferential coverage of insulation 204. Similarly, second edge 220B of second shell structure 202B is tucked underneath second flared end portion 212B of first shell structure 202A at the opposite side of the assembly. This overlapping configuration is provided to accommodate the fact that at least one of the shell structures can extend more than one-hundred-eighty degrees around the circumference of insulation 204, thereby ensuring no gaps exist through which insulation 204 could be exposed to the external environment.

FIG. 3D is a cross-sectional view through insulated tube assembly 200 of FIG. 3B taken through slot 214A and slot 214B. FIG. 3D shows plurality of wires 208 extending across first edge 218A and over first edge 220A of first shell structure 202A and second shell structure 202B, respectively, with first edge 220A being tucked under first flared end portion 212A. FIG. 3D also shows plurality of wires 208 extending across second edge 218B and over second edge 220B of first shell structure 202A and second shell structure 202B, respectively, with second edge 220B being tucked under second flared end portion 212B. This cross-sectional view illustrates a solution to reducing or eliminating the stress concentration problem: slot 214A and slot 214B extend completely through first shell structure 202A from an exterior, e.g., radially outer, side to an interior, e.g., radially inner side, at the location where plurality of wires 208 transitions from one side of the overlapping joint to the other, allowing the wires to maintain tangential contact with the shell structures rather than bending sharply over an edge.

In order to allow first shell structure 202A and second shell structure 202B to completely surround insulation 204, one or both of first shell structure 202A and second shell structure 202B can extend over more than one-hundred-eighty degrees around the circumference of insulation 204. This geometric configuration can be the same as in the design of FIG. 2A through FIG. 2E, arising from the desire to produce a complete enclosure without gaps while using two separate shell pieces that can be assembled around tube 206 and insulation 204. In the illustrated example, arcuate body 216 of second shell structure 202B can extend across approximately one-hundred-eighty degrees of insulation 204 between first edge 220A and second edge 220B, forming a semicircular or near-semicircular profile. Second shell structure 202B can comprise a C-shaped body that comprises a half cylinder, e.g., a body that extends around one-hundred-eighty degrees relative to the circumference of insulation 204. First shell structure 202A can extend across approximately two-hundred-twenty degrees of insulation 204 between first edge 218A and second edge 218B, thereby extending beyond a semicircle by approximately forty degrees to produce the overlap with second shell structure 202B. First shell structure 202A can comprise a U-shaped body that comprises a half cylinder, e.g., a body that extends around almost one-hundred-eighty degrees relative to the circumference of insulation 204, plus two straight portions extending therefrom comprising first flared end portion 212A and second flared end portion 212B. This overlap ensures that no portion of insulation 204 is exposed to the external environment and that the shell structures remain properly positioned during thermal cycling and vibration. Thus, in order to accommodate both of first shell structure 202A and second shell structure 202B partially encircling tube 206, first shell structure 202A can include first flared end portion 212A and second flared end portion 212B. These flared end portions transition outward from the primary curved profile of arcuate body 210 to create a larger radius that can accommodate the thickness of second shell structure 202B underneath. First edge 220A of second shell structure 202B can fit underneath first flared end portion 212A of first shell structure 202A and second edge 220B of second shell structure 202B can fit underneath second flared end portion 212B of first shell structure 202A, creating a nested or overlapping joint configuration at both circumferential locations where the two shell structures meet. The flared end portions additionally facilitate easier assembly by allowing a user to easily position first edge 220A and second edge 220B underneath first flared end portion 212A and second flared end portion 212B. Slot 214A and slot 214B at each of these overlapping joint locations can eliminate the stress concentration that would otherwise occur when plurality of wires 208 passes over first edge 218A and second edge 218B.

Slot 214A can comprise bottom end 222, first sidewall 224A, and second sidewall 224B. Slot 214B can be configured similarly to slot 214A, and further description thereof is omitted for brevity. Bottom end 222 can define the radially innermost extent of slot 214A, while first sidewall 224A and second sidewall 224B extend radially outward from bottom end 222 to define the axial boundaries of slot 214A. Bottom end 222 can extend in the axial direction, and first sidewall 224A and second sidewall 224B can extend in the circumferential direction.

Bottom end 222 can be positioned at the juncture between arcuate body 210 and flared end portion 212A. The geometry of slot 214A is designed to allow plurality of wires 208 to pass through first shell structure 202A in the circumferential direction while maintaining tangential contact with the shell structures. The width of slot 214A, defined by the spacing between first sidewall 224A and second sidewall 224B, can be sized to accommodate the diameter of plurality of wires 208 while providing sufficient clearance to allow the wires to pass through the slot without binding or excessive friction against the sidewalls.

As discussed with reference to FIG. 3E, bottom end 222 of slot 214A can be at the same radial position as arcuate body 216 of second shell structure 202B so that plurality of wires 208 can extend flush across arcuate body 210 and arcuate body 216 without a tangency difference caused by first edge 218A, thereby eliminating a stress concentration from plurality of wires 208 wrapping around first edge 218A. This configuration represents a solution to the stress concentration problem identified in the conventional design: by positioning bottom end 222 of slot 214A at the same radial distance from the center of tube 206 as the outer surface of arcuate body 216, plurality of wires 208 can maintain a constant radius of curvature as they transition from wrapping around arcuate body 210 to wrapping around arcuate body 216, without encountering a sharp edge that would create a stress concentration.

FIG. 3E is a close-up view of plurality of wires 208 extending across first edge 218A of first shell structure 202A and first edge 220A of second shell structure 202B in a tangential fashion, illustrating a configuration that eliminates or reduces the stress concentration problem present in fasteners bending around edges. As can be seen in FIG. 3E, arcuate body 216 of second shell structure 202B can extend around the circumference of insulation 204 such that first edge 220A extends along trajectory T4 that is tangent to insulation 204. This tangential trajectory represents the natural circular path that follows the outer surface of insulation 204 at a consistent radius. Similarly, arcuate body 210 of first shell structure 202A extends around insulation 204 in a circular manner until first shell structure 202A is in close proximity to first edge 220A of second shell structure 202B. Slot 214A can be positioned to allow bottom end 222 to circumferentially align with first edge 220A of second shell structure 202B at the same radial position. This radial alignment is a feature that facilitates elimination of stress concentration: by positioning bottom end 222 at the same radial distance from the center of tube 206 as first edge 220A, plurality of wires 208 can maintain tangential contact with both shell structures without encountering a change in radius or a sharp edge. As such, first shell structure 202A can extend tangentially relative to insulation 204 along trajectory T5 at the location of slot 214A. Trajectory T5 is at the same radial distance from the center of tube 206 as trajectory T4, meaning that plurality of wires 208 can transition smoothly from wrapping around arcuate body 216 to passing through slot 214A without bending at an angle or a sharp angle. Outside of slot 214A, arcuate body 210 can be redirected to extend over second shell structure 202B to form gap G2 in which arcuate body 216 is positioned, creating first flared end portion 212A. As such, plurality of wires 208 can extend in a circular fashion along both of arcuate body 210 and arcuate body 216 without a change in radius or without bending around an edge, such as first edge 220A of second shell structure 202B, thereby eliminating or reducing stress concentrations therefrom. This reduction and/or elimination of stress concentrations prevents rubbing and wear that can potentially cause wire failure in the conventional design, allowing insulated tube assembly 200 to withstand the differential thermal expansion and vibration that occurs during operation of the gas turbine engine without loosening or failure of plurality of wires 208. The tangential contact maintained by slot 214A distributes the retention force from plurality of wires 208 evenly across the curved surfaces of the shell structures, rather than concentrating the force at a sharp edge as in the conventional design, thereby preventing the localized stress that leads to wire breakage.

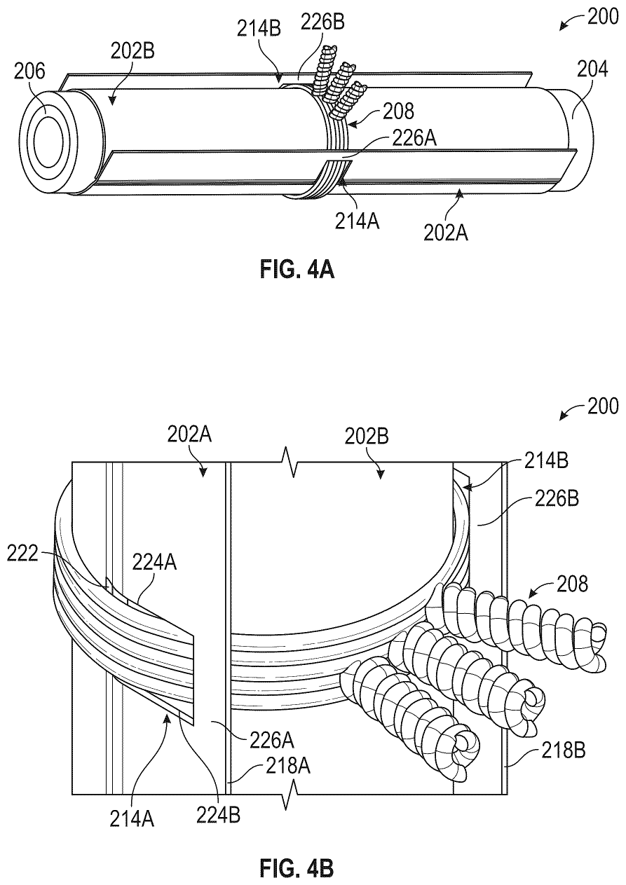

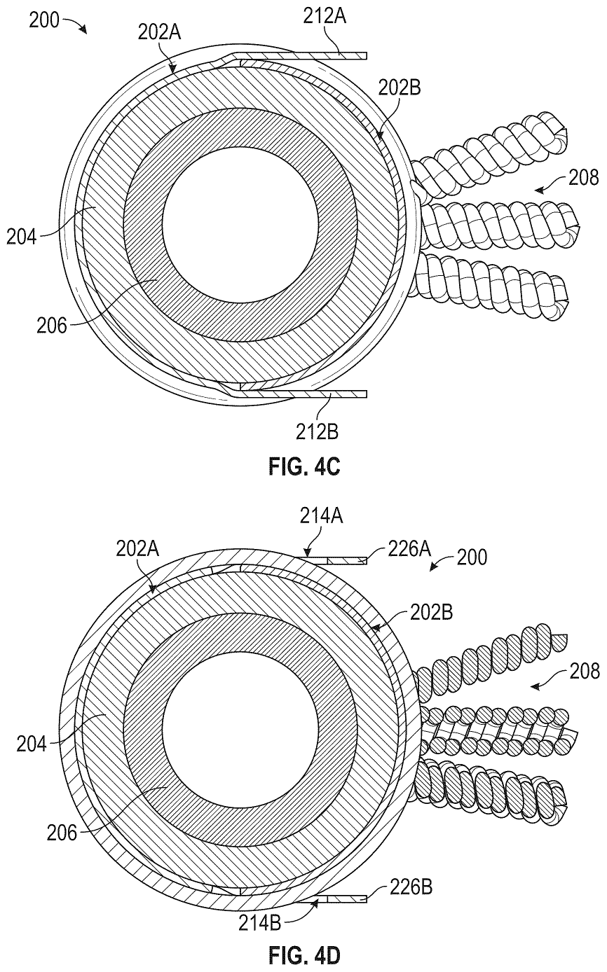

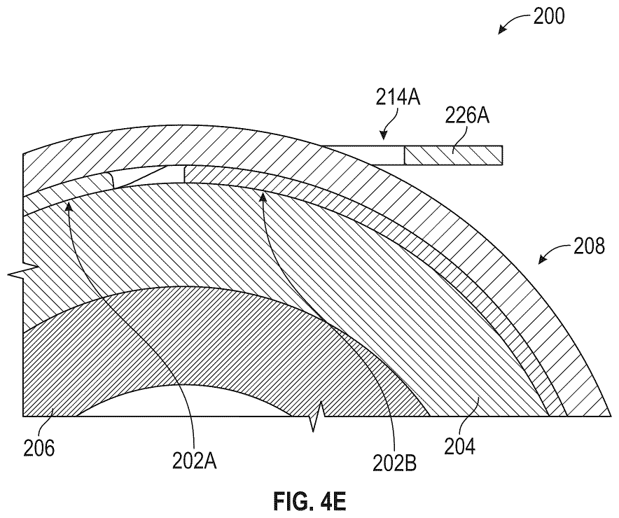

FIG. 4A, FIG. 4B, FIG. 4C, FIG. 4D, and FIG. 4E show various views of insulated tube assembly 200 similar to FIG. 3A through FIG. 3E, wherein first shell structure 202A and second shell structure 202B are held in place around insulation 204 against tube 206 via plurality of wires 208. Likewise, first shell structure 202A includes slot 214A and slot 214B. Slot 214A can comprise bottom end 222, first sidewall 224A and second sidewall 224B. However, in FIG. 4A through FIG. 4E, slot 214A includes a closed-end configuration having strap 226A, which represents a refinement over the open slot configuration shown in FIG. 3A through FIG. 3E. Likewise, slot 214B can include strap 226B that is configured similarly to strap 226A, but further discussion thereof is omitted for brevity.

Strap 226A can extend between first sidewall 224A and second sidewall 224B at the radially outer end of slot 214, opposite from bottom end 222. Thus, strap 226A can form the circumferential end of slot 214A and can align with first edge 218A. In additional examples, strap 226A can be circumferentially spaced from first edge 218A toward bottom end 222. Strap 226A provides structural stability to slot 214A and allows first edge 218A to extend in a continuous, straight manner without a discontinuity that would otherwise be present with an open-ended slot. Strap 226A can function to maintain the structural integrity of first shell structure 202A while still providing the stress concentration elimination benefits of slot 214A. Without strap 226A, slot 214A would create an open-ended cut in first shell structure 202A that could compromise the mechanical strength and stiffness of first shell structure 202A, particularly under the compressive forces applied by plurality of wires 208 and under thermal cycling conditions during operation of the gas turbine engine. Strap 226A bridges across the opening of slot 214A to maintain continuity of first edge 218A, preventing the edges of first shell structure 202A from separating or deforming at the location of slot 214A. Strap 226A can eliminate sharp edges that would otherwise be created by an open-ended slot terminating at first edge 218A. In the open slot configuration of FIG. 3A through FIG. 3E, the radially outer end of slot 214A terminates at first edge 218A, creating sharp corners at the intersection of first sidewall 224A and first edge 218A and at the intersection of second sidewall 224B and first edge 218A, if left untreated, e.g., filed down. These sharp corners could create stress concentrations in first shell structure 202A itself, potentially leading to cracking or deformation of first shell structure 202A at these locations under thermal cycling and mechanical loading. By incorporating strap 226A, these sharp corners can be eliminated, and first edge 218A can maintain a smooth, continuous profile along its entire length. The smooth profile can distribute mechanical loads more evenly across first shell structure 202A and prevents localized stress concentrations that could compromise the structural integrity of the shell. Additionally, strap 226A eliminates sharp edges that plurality of wires 208 might otherwise contact if the shell structure were to deform or if the wires were to shift position during operation. By maintaining a smooth, continuous edge profile, strap 226A ensures that plurality of wires 208 remain positioned within the radially inner portion of slot 214A where they can maintain tangential contact with the shell structures, rather than potentially riding up against sharp edges at the radially outer end of an open slot. Strap 226A can be integrally or monolithically formed with first shell structure 202A as a single piece, or can be a separate component that is welded, brazed, or mechanically fastened to first sidewall 224A and second sidewall 224B. In examples where strap 226A is integrally formed, first shell structure 202A can be manufactured by stamping, machining, or laser cutting to create slot 214A with strap 226A remaining as a bridging element. The thickness of strap 226A can be the same as the thickness of first shell structure 202A, or can be different to optimize the balance between structural support and clearance for plurality of wires 208. The width of strap 226A, measured in the longitudinal direction along bottom end 222, can be sized to provide adequate structural support while minimizing the longitudinal extent of slot 214A to maintain the overall strength of first shell structure 202A. Strap 226A is positioned radially outward from bottom end 222 of slot 214A, such that plurality of wires 208 pass through the radially inner portion of slot 214A defined by bottom end 222, first sidewall 224A, second sidewall 224B, and the radially inner surface of strap 226A. This configuration allows plurality of wires 208 to maintain tangential contact with the shell structures as described in FIG. 3E, while strap 226A maintains the structural integrity of first edge 218A and eliminates sharp edges. The presence of strap 226A prevents stress concentrations from developing in first shell structure 202A itself at the location of slot 214, which could otherwise occur due to the discontinuity created by an open-ended slot. Strap 226A also prevents first flared end portion 212A from spreading or deforming under the compressive forces applied by plurality of wires 208, ensuring that first shell structure 202A maintains proper engagement with second shell structure 202B throughout the thermal cycling and vibration experienced during operation of the gas turbine engine. The closed slot configuration with strap 226A therefore addresses the retention mechanism stress concentration problem identified in the design of FIG. 2A through FIG. 2E, while also addressing potential structural integrity issues that could arise from an open-ended slot, providing a design that maintains both the tangential wire contact benefits and the shell structure integrity.

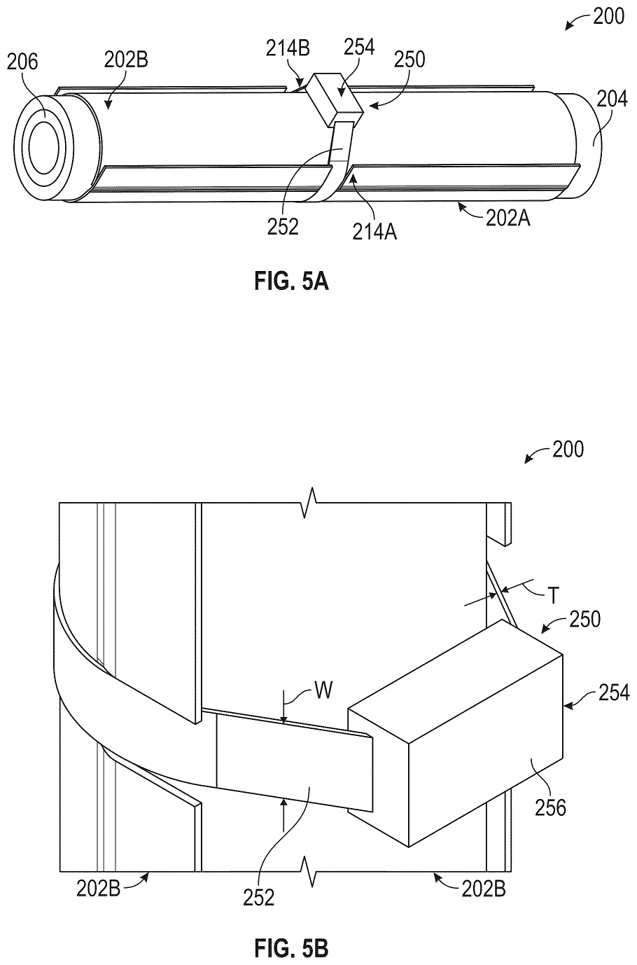

FIG. 5A and FIG. 5B show views of insulated tube assembly 200 similar to FIG. 3A and FIG. 3B. Thus, first shell structure 202A and second shell structure 202B can be held in place around insulation 204 against tube 206 via plurality of wires 208. Likewise, first shell structure 202A can include slot 214A. However, in FIG. 5A and FIG. 5B, plurality of wires 208 can be replaced by fastener assembly 250. Fastener assembly 250 can comprise strap 252 and lock mechanism 254. Strap 252 can comprise a flexible body that can be wrapped around insulated tube assembly 200. Strap 252 can comprise a tip or tail end that can be engaged with lock mechanism 254. Lock mechanism 254 can comprise head 256, or housing, having a slot into which the tip of strap 252 can be inserted. In examples, fastener assembly 250 can comprise a zip strip or zip tie assembly. In examples, fastener assembly 250 can comprise a head having a one-way ratchet mechanism, such as a pawl that permits the strap to be pulled tight, but not loosened, via engagement of teeth. In examples, strap 252 can include a gear rack comprising a plurality of notches, and the slot within head 256 can include a ratchet or detent that can engage with the gear rack of strap 252. Thus, strap 252 can be pulled through head 256 to cinch strap 252 around insulated tube assembly 200, but is prevented from migrating out of head 256 via lock mechanism 254.

In examples, fastener assembly 250 can be made of metal. In particular, strap 252 can be fabricated from a metal, such as stainless steel or another metal or alloy that offers high strength and high thermal resistance. Strap 252 can comprise a band that has a width W that is greater than thickness T. In examples, width W can be five to ten times greater than thickness T. The present disclosure provides additional benefits for such rectangular fastener straps. For example, strap 252 can extend continuously in the axial direction, e.g., across width W. As such, strap 252 can be less likely to flex, yield, or give as edges of first shell structure 202A and second shell structure 202B, as compared to plurality of wires 208, which comprises multiple strands extending across its width, thereby resulting in plurality of wires 208 having some degree of flexibility.

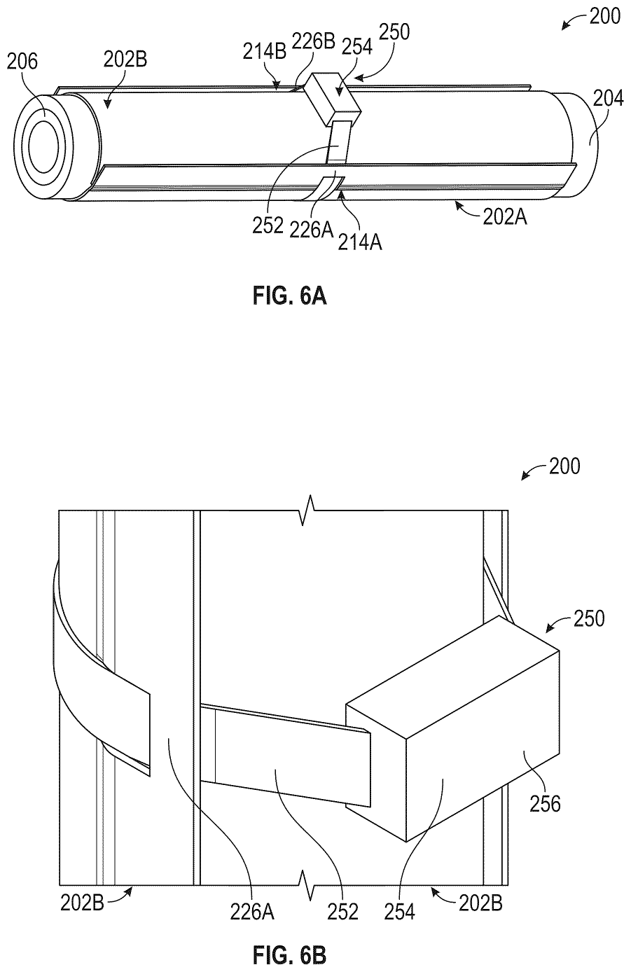

FIG. 6A and FIG. 6B show various views of insulated tube assembly 200 similar to FIG. 3A and FIG. 3B. Thus, first shell structure 202A and second shell structure 202B can be held in place around insulation 204 against tube 206 via plurality of wires 208. Likewise, first shell structure 202A can include slot 214A with strap 226A. However, in FIG. 6A and FIGS. 6B, plurality of wires 208 can be replaced by fastener assembly 250. Fastener assembly 250 can comprise strap 252 and lock mechanism 254. Fastener assembly 250 can be configured similarly to fastener assembly 250 as described with reference to FIG. 5A and FIG. 5B. Additionally, in FIG. 6A and FIG. 6B, slot 214A can include a closed end having strap 226A. Strap 226A can extend between first sidewall 224A and second sidewall 224B. Strap 226A can provide structural stability to slot 214A and allow for first edge 218A to extend in a straight manner without a discontinuity, as described with reference to FIG. 4A through FIG. 4E.

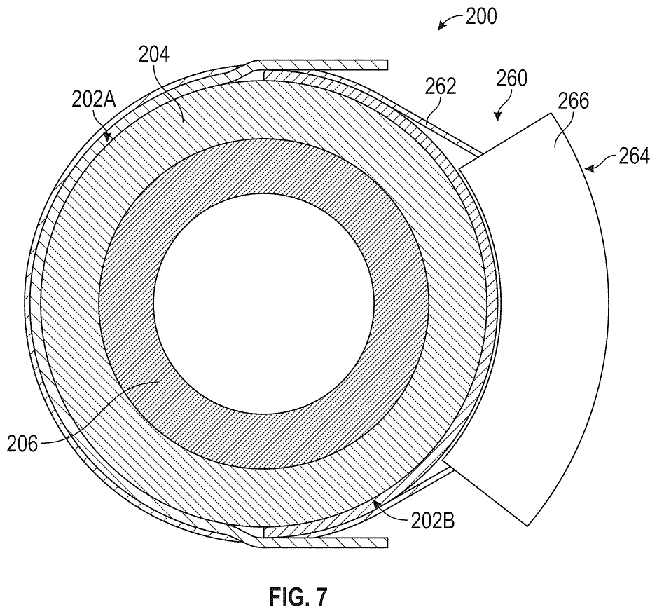

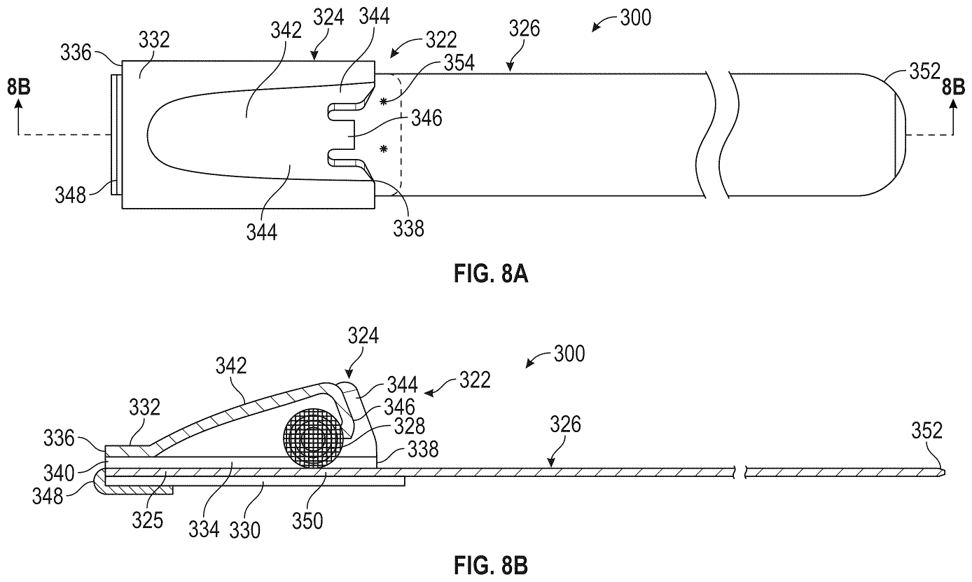

FIG. 7 is a cross-sectional view through insulated tube assembly 200 having fastener assembly 260 comprising strap 262 and lock mechanism 264. Fastener assembly 260 can comprise strap 262 and lock mechanism 264. Lock mechanism 264 can comprise head 266, or housing, having a slot into which the tip of strap 262 can be inserted. Fastener assembly 260 can be configured similarly to fastener assembly 250 as described with reference to FIG. 5A and FIG. 5B. However, in the example of FIG. 7, head 266 can be curved to mate with the curvature of insulated tube assembly 200. As such, head 266 can sit flush against insulated tube assembly 200 and will be less susceptible to rattling or vibration, such as due to air current within gas turbine engine 20, thereby reducing stress and wear on strap 262 and the potential for breakage. In the illustrated example, both the radial inner and radially outer surfaces of head 266 can be curved. In examples, only the radial inner surface of head 266 can be curved. In examples, the radially inner curved surface can be formed integrally or monolithically with head 266 or can comprise a separate body attached to head 266. The mating of head 266 flush with insulated tube assembly 200 can prevent distortions of head 266 that can potentially produce stress concentrations within head 266. Furthermore, the mating of head 266 flush with insulated tube assembly 200 can prevent distortions of head 266 that can potentially result in loosening of strap 262. FIG. 8A is a top view of fastener assembly 300 suitable for use with insulated tube

assembly 200 of FIG. 5A and FIG. 5B, showing locking head 324 and elongate strap 326. FIG. 8B is a side cross-sectional view through fastener assembly 300 of FIG. 8A showing a ball locking mechanism. FIG. 8A and FIG. 8B are discussed concurrently. FIG. 8A and FIG. 8B describe a cable tie such as is described in U.S. Pat. No. 4,366,602 A to Conlon et al., titled “Metal Tie,” the contents of which are hereby incorporated herein in their entirety by this reference. Fastener assembly 300 can comprise a wedged-ball locking mechanism.

Fastener assembly 300 can comprise cable tie 322 configured to encircle and secure shell structures around insulated tubing. Cable tie 322 includes locking head 324 joined to end 325 of elongate strap 326 and ball 328, which can comprise a sphere, retained within locking head 324 for locking elongate strap 326 within locking head 324. In examples, ball 328, locking head 324, and elongate strap 326 can be formed of stainless steel to allow cable tie 322 to be used over a wide temperature range and provide high strength and resistance to corrosion in the gas turbine engine environment.

Locking head 324 comprises floor 330, ceiling 332, and a pair of side walls 334 interconnecting floor 330 and ceiling 332. Locking head 324 further includes strap entry face 336, exit face 338, and strap-receiving aperture 340 extending between strap entry face 336 and exit face 338 and partially defined by side walls 334 and ceiling 332. Locking head 324 also comprises roof 342 which overlies floor 330 and diverges therewith in the direction of exit face 338. One end of roof 342 joins ceiling 332 with spaced side wings 344 connecting other parts of roof 342 and ceiling 332. Roof 342 is arcuate to provide an inside surface of roof 342 with a shape complementary to that of ball 328 which it engages. Extending from roof 342 toward floor 330 and adjacent to exit face 338 is finger 346, which functions as a retention mechanism for retaining ball 328 within locking head 324. In examples, floor 330 can be flat or planar as shown in FIG. 8B. In examples, floor 330 can be curved similarly to what is shown in FIG. 7 to allow locking head 324 to mate flush or nearly flush with a curved surface.

Cable tie 322 also comprises a retention mechanism for retaining locking head 324 at end 325 of elongate strap 326 to preclude sliding of locking head 324 relative to elongate strap 326. End 325 of elongate strap 326 includes a head retaining mechanism in the form of hooked portion 348 for receiving and holding floor 330 adjacent to strap entry face 336. In examples, hooked portion 348 can be crimped about floor 330, or elongate strap 326 can be welded to floor 330 at weld spots 354 to provide additional strength. In examples, another hooked portion or stop can be formed from elongate strap 326 to hold floor 330 adjacent to exit face 338. End 325 also includes portion 350 underlying roof 342, and, together with ceiling 332 and side walls 334, defining strap-receiving aperture 340. The remainder of elongate strap 326 extends from locking head 324 and terminates in tip 352, which can be tapered by coining to facilitate reception into locking head 324.

Ball 328, which constitutes a roller mechanism captively held within locking head 324 by finger 346, has a textured or roughened surface to increase the coefficient of friction between ball 328 and roof 342 or elongate strap 326. Ball 328 is movable from a threading position, wherein ball 328 concurrently engages finger 346 and elongate strap 326 but is spaced from roof 342, toward a locking position in which ball 328 is closer to strap entry face 336 and concurrently engages roof 342 and elongate strap 326 to wedge elongate strap 326 against floor 330 to prevent retrograde movement of elongate strap 326 in locking head 324. In the locking position, ball 328 pushes the portion of elongate strap 326 inserted under ball 328 against end 325, which is in turn pushed against floor 330, thereby securing elongate strap 326 within locking head 324. Ceiling 332 and the portions of ceiling 332 adjacent to exit face 338, which diverge to straddle roof 342, constitute a mechanism for limiting movement of elongate strap 326 toward roof 342 during threading. Tip 352 and ceiling 332 cooperate to ensure that, during threading, ball 328 is engaged beneath its center of gravity so that ball 328 will be lifted to its threading position, allowing elongate strap 326 to be pulled through locking head 324. Once elongate strap 326 is tightened around the shell structures, any retrograde force causes ball 328 to move to its locking position, wedging elongate strap 326 against floor 330 and preventing loosening of fastener assembly 300.

The present disclosure addresses problems in maintaining insulated tube assemblies within gas turbine engine structures where differential thermal expansion and vibration can cause loosening and failure of retention mechanisms. Conventional designs position retention bands, such as wires, around overlapping shell structures that encircle insulation material on the exterior of fluid tubes. These conventional designs can result in stress concentrations where the retention wires contact sharp edges of the shell structures rather than maintaining tangential contact with curved surfaces. The present disclosure eliminates these stress concentrations by incorporating slots in the shell structures at locations where overlapping edges would otherwise disrupt the tangency of the retention bands. The slots allow retention bands to maintain a constant radius of curvature as they encircle the shell structures, preventing the sharp bending and edge contact that causes rubbing, wear, and eventual failure of the retention mechanism. The slots can be configured as open-ended slots that extend completely through the edge of the shell structure to the outer periphery, or as closed slots having a bridging strap that maintains structural integrity of the shell edge while still providing a recessed pathway for the retention band. The closed slot configuration with a strap eliminates sharp corners that could create stress concentrations in the shell structure itself while preventing the retention band from contacting edges. The bottom end of each slot is positioned at the same radial distance from the center of the tubular body as the outer surface of the underlying shell structure, ensuring that the retention band maintains tangential contact throughout its entire circumference without encountering changes in radius or sharp edges.

The insulated tube assemblies of the present disclosure can be implemented in gas turbine engines where support structures include inner rings, outer rings, and webs that define pathways for routing insulated tubes between different sections of the engine. The insulated tubes convey cooling fluids, such as oil or air, to bearing assemblies and other components that require temperature control during engine operation. In typical applications, the external environment surrounding the insulated tube can reach temperatures of approximately 1300° F. (~704° C.) while the fluid within the tube is maintained at approximately 300° F. (~149° C.), creating a temperature differential of approximately 1000° F. (~538° C.). This temperature differential benefits from effective insulation to prevent undesirable heating of the cooling fluid. However, the insulation material and surrounding shell structures heat up more than the tube itself during operation, causing differential thermal expansion that loosens retention mechanisms in conventional designs. The slot-based retention systems of the present disclosure accommodate this differential thermal expansion by maintaining tangential contact between retention bands and shell structures, allowing the components to expand and contract without creating loosening or stress concentrations. The retention bands can comprise wires twisted together at their ends to cinch around the shell structures, or can comprise cable ties with locking heads that allow adjustment and secure fastening. Cable tie embodiments can include ball locking mechanisms within locking heads that permit threading of an elongate strap through the locking head while preventing retrograde movement once tightened. The ball mechanism moves between a threading position that allows the strap to advance and a locking position that wedges the strap against a floor to prevent loosening. These fastener assemblies can be formed of stainless steel to provide high strength, corrosion resistance, and stability across the wide temperature range encountered in gas turbine engine environments. The combination of slot-based shell structures and robust retention mechanisms provides insulated tube assemblies that maintain secure engagement throughout thermal cycling and vibration, preventing the rattling, rubbing, and failure that occurs in conventional designs.

### EXAMPLES

Example 1 is an insulated tube assembly comprising: a tubular body including an exterior surface and an internal lumen; an insulation member positioned on the exterior surface; a heat shield comprising: a first shell structure comprising: a first body having a first end and a second end between which the insulation member can be fit; a first slot positioned along the first end; and a second slot positioned along the second end; and a second shell structure comprising: a second body having a third end and a fourth end between which the insulation member can fit; wherein the third end and the fourth end can fit underneath the first end and the second end, respectively, so that the first body and the second body encircle the insulation member; and a retention band extending through the first slot and the second slot to encircle the first shell structure and the second shell structure.

In Example 2, the subject matter of Example 1 optionally includes wherein: the first end includes a first flared portion extending at a different trajectory than the first body; and the second end includes a second flared portion extending at a different trajectory than the first body.

In Example 3, the subject matter of Example 2 optionally includes wherein: the first slot extends to where the first flared portion meets the first body; and the second slot extends to where the second flared portion meets the first body.

In Example 4, the subject matter of any one or more of Examples 2-3 optionally include wherein: the first flared portion overlaps the third end and extends away from the second body; and the second flared portion overlaps the fourth end and extends away from the second body.

In Example 5, the subject matter of any one or more of Examples 2-4 optionally include wherein: the first slot comprises: a first bottom end; and a first sidewall and a second sidewall extending from the first bottom end along the first flared portion; and the second slot comprises: a second bottom end; and a third sidewall and a fourth sidewall extending from the second bottom end along the second flared portion.

In Example 6, the subject matter of Example 5 optionally includes wherein: the first bottom end and the third end of the second body are circumferentially aligned; and the second bottom end and the fourth end of the second body are circumferentially aligned.

In Example 7, the subject matter of any one or more of Examples 5-6 optionally include wherein: the first sidewall and the second sidewall extend radially outward from the first bottom end; and the third sidewall and the fourth sidewall extend radially outward from the second bottom end.

In Example 8, the subject matter of any one or more of Examples 5-7 optionally include wherein: the first slot further comprises a first strap extending between the first sidewall and the second sidewall opposite the first bottom end; and the second slot further comprises a second strap extending between the third sidewall and the fourth sidewall opposite the second bottom end.

In Example 9, the subject matter of Example 8 optionally includes wherein: the first strap is positioned at a first circumferential end of the first sidewall and the second sidewall; and the second strap is positioned at a second circumferential end of the third sidewall and the fourth sidewall.

In Example 10, the subject matter of any one or more of Examples 1-9 optionally include wherein the retention band comprises a plurality of wires.

In Example 11, the subject matter of any one or more of Examples 1-10 optionally include wherein the retention band comprises a strap having a width larger than a thickness, the strap comprising a locking mechanism to hold portions of the strap against each other in a wound configuration around the heat shield.

In Example 12, the subject matter of Example 11 optionally includes wherein the retention band comprises a metal tie having a wedged-ball locking mechanism.

In Example 13, the subject matter of any one or more of Examples 11-12 optionally include wherein the locking mechanism comprises a housing having a curvature to engage with the heat shield.

Example 14 is a gas turbine engine comprising: a compressor section; a combustor section downstream of the compressor section; a turbine section downstream of the combustor section; a support structure positioned within the gas turbine engine, the support structure comprising an inner ring, an outer ring, and a web extending between the inner ring and the outer ring; and an insulated tube assembly extending through the support structure, the insulated tube assembly comprising: a tubular body including an exterior surface and an internal lumen configured to convey fluid; an insulation member positioned on the exterior surface; a heat shield comprising a first shell structure and a second shell structure that encircle the insulation member, wherein at least one of the first shell structure and the second shell structure includes a slot extending therethrough; and a retention band extending through the slot to encircle the first shell structure and the second shell structure.

In Example 15, the subject matter of Example 14 optionally includes wherein the tubular body is configured to convey cooling fluid to a bearing assembly that supports a rotating shaft within the gas turbine engine.

In Example 16, the subject matter of any one or more of Examples 14-15 optionally include wherein: the slot comprises a bottom end positioned at a radial distance from a center of the tubular body; and the retention band extends through the slot such that the retention band maintains tangential contact with both the first shell structure and the second shell structure without encountering a change in radius.

In Example 17, the subject matter of any one or more of Examples 14-16 optionally include wherein the slot includes a strap extending axially across the slot to maintain structural integrity of the first shell structure while allowing the retention band to pass through a radially inner portion of the slot.

Example 18 is an insulated tube assembly comprising: a tubular body including an exterior surface and an internal lumen configured to convey fluid; an insulation member positioned on the exterior surface; a heat shield comprising a first shell structure and a second shell structure that encircle the insulation member, wherein the first shell structure includes a slot extending therethrough; and a retention band extending through the slot to encircle the first shell structure and the second shell structure; wherein the slot permits the retention band to maintain tangency with the heat shield around a circumference of the heat shield.

In Example 19, the subject matter of Example 18 optionally includes wherein: the second shell structure includes a longitudinal edge; the first shell structure includes a flared end portion under which the longitudinal edge is disposed; and the slot is positioned at a juncture of the flared end portion with the first shell structure.

In Example 20, the subject matter of any one or more of Examples 18-19 optionally include wherein: the first shell structure comprises an interior surface facing the insulation member and an exterior surface facing the retention band; and the slot extends from the interior surface to the exterior surface.

Example 21 is a heat shield for an insulated tube assembly configured for use in a gas turbine system, the heat shield comprising: a first shell structure comprising: an arcuate body having a first longitudinal edge and a second longitudinal edge; a first flared portion extending from the first longitudinal edge at a different trajectory than the arcuate body; a second flared portion extending from the second longitudinal edge at a different trajectory than the arcuate body; a first slot positioned at the first flared portion at the first longitudinal edge; and a second slot positioned at the second flared portion at the second longitudinal edge.

In Example 22, the subject matter of Example 21 optionally includes wherein: the first slot comprises: a first bottom end; and a first sidewall and a second sidewall extending from the first bottom end along the first flared portion; and the second slot comprises: a second bottom end; and a third sidewall and a fourth sidewall extending from the second bottom end along the second flared portion.

In Example 23, the subject matter of Example 22 optionally includes wherein: the first slot further comprises a first strap connecting the first sidewall and the second sidewall opposite the first bottom end; and the second slot further comprises a second strap connecting the third sidewall and the fourth sidewall opposite the second bottom end.

In Example 24, the subject matter of Example 23 optionally includes wherein: the first strap is positioned at a first circumferential end of the first flared portion; and the second strap is positioned at a second circumferential end of the second flared portion.

In Example 25, the subject matter of any one or more of Examples 21-24 optionally include wherein: the arcuate body extends across approximately one-hundred-eighty degrees between the first longitudinal edge and the second longitudinal edge; and the first shell structure extends around approximately two-hundred-twenty degrees between a first circumferential end of the first flared portion and a second circumferential end of the second flared portion.

In Example 26, the subject matter of any one or more of Examples 21-25 optionally include wherein the first shell structure is formed of aluminum or ceramic.

In Example 27, the subject matter of any one or more of Examples 21-26 optionally include the first shell structure having a thickness in the range of approximately 3.2 mm to approximately 12.7 mm.

### Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” or “approximately” is used in conjunction with a numerical range, it modifies that range by extending the boundaries above and below the numerical values set forth. In general, the term “about” or “approximately” is used herein to modify a numerical value above and below the stated value by a variance of 10%. In one aspect, the term “about” or “approximately” means plus or minus 10% of the numerical value of the number with which it is being used. Therefore, “about 50%” or “approximately 50%” means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about” or “approximately.”

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An insulated tube assembly comprising:
a tubular body including an exterior surface and an internal lumen;
an insulation member positioned on the exterior surface;
a heat shield comprising:
a first shell structure comprising:
a first body having a first end and a second end between which the insulation member can be fit;
a first slot positioned along the first end; and
a second slot positioned along the second end; and
a second shell structure comprising:
a second body having a third end and a fourth end between which the insulation member can fit;
wherein the third end and the fourth end can fit underneath the first end and the second end, respectively, so that the first body and the second body encircle the insulation member; and
a retention band extending through the first slot and the second slot to encircle the first shell structure and the second shell structure.

2. The insulated tube assembly of claim 1, wherein:
the first end includes a first flared portion extending at a different trajectory than the first body; and
the second end includes a second flared portion extending at a different trajectory than the first body.

3. The insulated tube assembly of claim 2, wherein:
the first slot extends to where the first flared portion meets the first body, and
the second slot extends to where the second flared portion meets the first body.

4. The insulated tube assembly of claim 2, wherein:
the first flared portion overlaps the third end and extends away from the second body; and
the second flared portion overlaps the fourth end and extends away from the second body.

5. The insulated tube assembly of claim 2, wherein:
the first slot comprises:
a first bottom end; and
a first sidewall and a second sidewall extending from the first bottom end along the first flared portion; and
the second slot comprises:
a second bottom end; and
a third sidewall and a fourth sidewall extending from the second bottom end along the second flared portion.

6. The insulated tube assembly of claim 5, wherein:
the first bottom end and the third end of the second body are circumferentially aligned; and
the second bottom end and the fourth end of the second body are circumferentially aligned.

7. The insulated tube assembly of claim 5, wherein:
the first sidewall and the second sidewall extend radially outward from the first bottom end; and
the third sidewall and the fourth sidewall extend radially outward from the second bottom end.

8. The insulated tube assembly of claim 5, wherein:
the first slot further comprises a first strap extending between the first sidewall and the second sidewall opposite the first bottom end; and
the second slot further comprises a second strap extending between the third sidewall and the fourth sidewall opposite the second bottom end.

9. The insulated tube assembly of claim 8, wherein:
the first strap is positioned at a first circumferential end of the first sidewall and the second sidewall; and
the second strap is positioned at a second circumferential end of the third sidewall and the fourth sidewall.

10. The insulated tube assembly of claim 1, wherein the retention band comprises a plurality of wires.

11. The insulated tube assembly of claim 1, wherein the retention band comprises a strap having a width larger than a thickness, the strap comprising a locking mechanism to hold portions of the strap against each other in a wound configuration around the heat shield.

12. The insulated tube assembly of claim 11, wherein the retention band comprises a metal tie having a wedged-ball locking mechanism.

13. The insulated tube assembly of claim 11, wherein the locking mechanism comprises a housing having a curvature to engage with the heat shield.

14. A gas turbine engine comprising:
a compressor section;
a combustor section downstream of the compressor section;
a turbine section downstream of the combustor section;
a support structure positioned within the gas turbine engine, the support structure comprising an inner ring, an outer ring, and a web extending between the inner ring and the outer ring; and
an insulated tube assembly extending through the support structure, the insulated tube assembly comprising:
a tubular body including an exterior surface and an internal lumen configured to convey fluid;
an insulation member positioned on the exterior surface;
a heat shield comprising a first shell structure and a second shell structure that encircle the insulation member, wherein at least one of the first shell structure and the second shell structure includes a slot extending therethrough; and
a retention band extending through the slot to encircle the first shell structure and the second shell structure.

15. The gas turbine engine of claim 14, wherein the tubular body is configured to convey cooling fluid to a bearing assembly that supports a rotating shaft within the gas turbine engine.

16. The gas turbine engine of claim 14, wherein:
the slot comprises a bottom end positioned at a radial distance from a center of the tubular body; and
the retention band extends through the slot such that the retention band maintains tangential contact with both the first shell structure and the second shell structure without encountering a change in radius.

17. The gas turbine engine of claim 14, wherein the slot includes a strap extending axially across the slot to maintain structural integrity of the first shell structure while allowing the retention band to pass through a radially inner portion of the slot.

18. A heat shield for an insulated tube assembly configured for use in a gas turbine system, the heat shield comprising:
a first shell structure comprising:
an arcuate body having a first longitudinal edge and a second longitudinal edge;
a first flared portion extending from the first longitudinal edge at a different trajectory than the arcuate body;
a second flared portion extending from the second longitudinal edge at a different trajectory than the arcuate body;
a first slot positioned at the first flared portion at the first longitudinal edge; and
a second slot positioned at the second flared portion at the second longitudinal edge.

19. The heat shield of claim 18, wherein:
the first slot comprises:
a first bottom end; and
a first sidewall and a second sidewall extending from the first bottom end along the first flared portion; and
the second slot comprises:
a second bottom end; and
a third sidewall and a fourth sidewall extending from the second bottom end along the second flared portion.

20. The heat shield of claim 19, wherein:
the first slot further comprises a first strap connecting the first sidewall and the second sidewall opposite the first bottom end; and
the second slot further comprises a second strap connecting the third sidewall and the fourth sidewall opposite the second bottom end.
